(19) United States
(12) Patent Application Publication
(10) Pub. No.: US 2016/0289116 A1
(43) Pub. Date: Oct. 6, 2016

(54) METHOD FOR FLUORINATING DOPED QUARTZ GLASS

(71) Applicant: HERAEYS QUARZGLAS GMBH & CO. KG, Hanau (DE)

(72) Inventors: Andreas LANGNER, Freigericht (DE); Gerhard SCHOETZ, Aschaffenburg (DE); Mario SUCH, Graefenhainichen (DE); Malte SCHWERIN, Halle an der Saale (DE); Martin TROMMER, Bitterfeld (DE); Stephan GRIMM, Jena (DE); Andre KALIDE, Neustadt an der Orla (DE); Martin LEICH, Jena (DE); Florian JUST, Jena (DE)

(73) Assignee: Heraeus Quarzglas GmbH & Co. KG, Hanau (DE)

(21) Appl. No.: 14/778,549

(22) PCT Filed: Mar. 18, 2014
(86) PCT No.: PCT/EP2014/055400

§ 371 Date: Sep. 18, 2015

(30) Foreign Application Priority Data
Mar. 19, 2013 (DE) 10 2013 204 815.7

(51) Int. Cl. C03C 4/00; C03C 3/06; C03B 19/12

(52) U.S. Cl. CPC C03C 4/0071; C03B 19/12; C03C 3/06; C03B 2201/12; C03B 2201/36; C03C 2201/3488; C03C 2203/22; C03C 2203/54; C03C 2201/12

(57) ABSTRACT

The invention describes a method for the manufacture of quartz glass that comprises not only doping with rare earth elements and/or transition metals, but also fluorination of the quartz glass. The method described presently allows the diffusion of the dopants during fluorination to be prevented. Moreover, the invention relates to the quartz glass that can be obtained according to the method according to the invention and the use thereof as laser-active quartz glass, for generating light-guiding structures, and in optical applications.

### BACKGROUND

One embodiment of the present invention relates to a method for the manufacture of doped quartz glass. One embodiment of the present invention also relates to quartz glass that can be obtained according to the method presented, and the use thereof in laser technology, for example as large-mode-area fibre, anti-guiding laser fibre, fibre end-caps, core-cladding glass fibres or in light-guiding structures.

Laser technology is one of the main application fields of quartz glass, where it is used, for example, for the manufacture of fibre amplifiers or fibre lasers. For this purpose, the quartz glass is doped with foreign atoms that effect an increase of the laser radiation in the quartz glass as the host material. Usually, these doping materials are rare earth elements, such as ytterbium, and transition metals, such as, for example, chromium and titanium, which attain the highest possible amplification performance. The amount of foreign atoms that can be incorporated into the quartz glass is limited though, since the laser radiation to be amplified is actually attenuated from a certain concentration. Concurrently, doping the quartz glass changes its refractive index which leads to undesirable effects. In order to counteract these disadvantages, the quartz glass is additionally doped with fluorine, which is known to lower the refractive index, for example.

U.S. Pat. No. 5,262,365 describes the manufacture of a porous glass body that can be manufactured by means of VAD or OVD methods or, alternatively, by means of the sol-gel method. Said body is doped with aluminium and rare earth elements first and then with fluorine in a second step. The aim of said method is the manufacture of a doped quartz glass that is transparent and free of bubbles.

DE 10 2004 006 017 B4 describes a method for the manufacture of laser-active quartz glass, in which a compact is made from a dispersion of SiO₂ powder, rare earth metal cations, and transition metal cations, and is dried by heating to a temperature of at least 1,000° C. and purified in further steps and thus comprises an OH content of less than 10 ppm before sintering it to form the doped quartz glass.

US 2007/0297735 A1 describes an optical fibre, whose core contains not only alkali metal oxides, such as K₂O, Na₂O, Li₂O, Rb₂O or Cs₂O, but also chlorine and fluorine, whereby the average concentration of fluorine exceeds that of the alkali metal oxides. The fibre attenuation can be optimised by appropriate selection of the concentration of the alkali metal oxide doping.

US 2011/0116160 A1 discloses an optical fibre amplifier, whose core is doped by rare earth nano-particles embedded in a core matrix. The rare earth elements can be erbium, thulium or ytterbium. Moreover, the core contains an additional doping agent such as germanium, fluorine, aluminium or phosphorus.

### BRIEF DESCRIPTION OF THE DRAWINGS

The accompanying drawings are included to provide a further under-standing of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 illustrates an ESMA analysis by means of a WDX scan across an Yb/Al-doped quartz glass sample that was manufactured according to Example 1 of the method according to one embodiment of the invention.

FIG. 2 illustrates a comparison of two fibres doped with similar Yb and Al concentrations and the fluoride-containing fibre manufactured according to the method according to one embodiment of the invention.

FIG. 3 illustrates a fibre attenuation spectrum of a glass manufactured according to the method according to one embodiment of the invention.

FIG. 4 illustrates two samples of which one is doped with fluorine alone, whereas the second was manufactured according to the method according to one embodiment of the invention.

FIG. 5 illustrates a refractive index profile of a quartz glass manufactured according to Example 4.

FIG. 6 illustrates the attenuation spectrum of a quartz glass manufactured according to Example 4 from which a fibre with an external diameter of 125 μm was produced at a drawing temperature of 1,850° C. and a drawing rate of 10 m/min without any further cladding steps.

FIG. 7 illustrates the refractive index profile of a quartz glass manufactured according to Example 2.

FIG. 8 illustrates the elemental distribution of a quartz glass manufactured according to Example 2 as determined by electron beam microscopy.

FIG. 9 illustrates the refractive index structure of a quartz glass manufactured according to Example 1, which is doped with 0.12 mol % Yb₂O₃, 0.5 mol % Al₂O₃, and 0.8 mol % SiF₄, with a strong drop of the refractive index as compared to non-doped quartz glass, suitable for manufacture of an anti-guiding laser fibre.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

The effect of fluorine doping is that a fraction of the cations of rare earth elements and/or transition metals introduced earlier diffuse out of the quartz glass again during the fluorination such that the optical properties of the quartz glass cannot be adjusted optimally as desired.

It is therefore the object of one embodiment of the present invention to provide a fluorination method for doped quartz glass, in which the rare earth elements are prevented from diffusing out during the fluorination, and which also ensures homogeneous distribution of the doping agents in the quartz glass.

The object can be met according to one embodiment of the invention in that an intermediate product doped earlier with doping agents is produced from a dispersion by precipitation and is treated with a gaseous fluorine source in a separate step before producing the doped quartz glass by sintering.

Accordingly, one subject matter of one embodiment of the present invention is a method for the manufacture of doped quartz glass comprising the following steps of:
a) providing a dispersion containing
   1) SiO₂ particles and
   2) a component selected from the group consisting of a doping agent, a precursor substance of a doping agent, and any mixture thereof, in a liquid;
b) generating a precipitate of at least a part of a doping agent and/or the precursor substance of a doping agent in the dispersion;
c) reducing the amount of the liquid phase of the dispersion while forming a doped intermediate product;
d) treating the doped intermediate product with a gas or a gas mixture containing one or more gaseous fluorine source(s) while generating a fluorinated intermediate product;
e) sintering the fluorinated intermediate product while forming the doped quartz glass.

In the scope of one embodiment of the present invention, the doping agent comprises at least one substance that is added to the quartz glass on purpose in order to attain desired properties. The purpose of the doping agent or doping agents is to improve or adjust the mechanical and optical properties of the doped quartz glass, such as, for example, the refractive index or the viscosity. In the scope of one embodiment of the present invention, a precursor substance of a doping agent shall be understood to be any substance which is converted into the actual doping agent in a later stage of the method due to a chemical reaction or through changing its oxidation state. In as far as reference to doping agent is made hereinafter, said term shall, for reasons of simplification, also comprise a starting compound or precursor substance of a doping agent unless expressly specified otherwise or unless evident from the circumstances. In the scope of one embodiment of the present invention, it is preferred to use one or more doping agent(s) as well as a mixture of different doping agents. For clarity, the term, doping agent, shall therefore represent one or more doping agent(s) and/or a mixture of different doping agents unless expressly specified otherwise or unless evident from the circumstances.

In a preferred refinement of one embodiment of the present invention, the liquid, in which the SiO₂ particles and the doping agent are dispersed, comprises water. Preferably, the water content of the liquid is more than 70%, more preferably more than 80%, and in particular more than 90%. The liquid can, for example, be an ammoniacal solution.

Therefore, the dispersion preferably is a suspension.

In one embodiment of the method according to the invention, the dispersion of SiO₂ particles is homogenised in the absence of the doping agent first and the doping agent or a precursor substance of a doping agent, in dissolved form, is then added to said homogenised dispersion.

In one embodiment of the method according to the invention, metal compounds, preferably one or more oxides of rare earth elements and/or transition metals, are used as doping agent. Preferably, the method according to one embodiment of the invention is characterised in that one or more oxides of rare earth elements is/are used as doping agent and/or precursor substance of the doping agent.

In the scope of one embodiment of the present invention, the term of rare earth elements is used summarily to refer to the lanthanides, elements of the third sub-group of the periodic table of the elements, and scandium and yttrium. Starting compounds and suitable solvents for said doping agents are known to a person skilled in the art. Examples of precursor substances or starting compounds include chlorides, such as YbCl₃ or ErCl₃. Said precursor substances are then converted into the corresponding oxides, as the actual doping agents, in the course of the process. Said conversion can take place, for example, in the scope of a chemical reaction. In the scope of one embodiment of the present invention, a doping agent shall be understood to be a compound that comprises the dopant and can release the dopant during the doping process. The dopant is usually present in the form of an ion, usually as a cation, and is the actual substance doping the quartz glass. Doping with ytterbium shall be used for exemplary and illustrative purposes. In this exemplary, but in no way limiting, case, YbCl₃ is understood to be the precursor substance in the scope of one embodiment of the present invention that is converted, for example by means of a chemical reaction, into the oxide (e.g. Yb₂O₃), which is the doping agent in the present case. Said doping agent in turn releases the dopant, i.e. the Yb cation in the present case, which is then incorporated into the quartz glass.

Preferably, one or more oxides of rare earth elements are used as doping agents and/or precursor substances thereof, preferably are used in combination with an oxide selected from the group consisting of aluminium oxide, boron oxide, and phosphorus oxide as well as any mixtures thereof.

In one embodiment of the method according to the invention, one or more oxides selected from the group consisting of Al₂O₃, Yb₂O₃, Ce₂O₃, Nd₂O₃, Sm₂O₃, Er₂O₃, Tm₂O₃, La₂O₃, Y₂O₃, Eu₂O₃, Ho₂O₃, Pr₂O₃, NbO₂, Ni₂O₃, Sc₂O₃, TaO₂, ZrO₂, GeO₂, B₂O₃, P₂O₃, SnO₂, CrO, Cr₂O₃, CrO₂, NiO, ZnO, MgO, CaO, SrO, BaO, MnO₂, Ga₂O₃, and TiO₂ are used as doping agents. It is preferable to use mixtures of two or more doping agents. Particularly good results in terms of the incorporation of fluorine and the diffusion of rare earth dopants out of the material during the fluorination are attained when aluminium is used as co-dopant, since it acts as a solubiliser. It is preferable to use Al₂O₃ as doping agent and Al cations as dopant in this context.

In a preferred embodiment, a mixture of Al₂O₃ and one or more oxides of rare earth elements is used as doping agent. Particularly preferably, the quantity of Al₂O₃ that is present is larger than the quantity of the rare earth oxide(s). Specifically, the molar ratio of Al₂O₃ to the sum of rare earth metal oxides is at least 2:1, preferably at least 3:1, in particular at least 4:1. A combination of Al₂O₃ and Yb₂O₃ is specifically preferred. Alternatively or as a supplement, the Al₂O₃ can just as well be replaced by phosphorus oxides and/or boron oxides.

Preferably, the doping agents are added to the dispersion in the form of one or more doping agent solutions. In this context, addition in the form of a single doping agent solution is preferred provided the doping agents can be solubilised in the presence of each other.

The addition of the doping agents to the dispersion can be associated with local over-saturation and ensuing inhomogeneous distribution, which, in turn, leads to the desired formation of glass not being attained. To counter-act this effect, a procedure is preferred, in which the dispersion is mechanically agitated during the addition of the doping agent. In this context, the agitation of the suspension is effected by means of known and suitable methods, such as, for example, stirring, vortexing, shaking or the use of ultrasound.

In one embodiment of the method according to the invention, providing the dispersion in step a) takes place by SiO₂ particles present in a liquid being added to the doping agent(s) and/or the precursor substance(s) thereof in the form of droplets and/or through a spray mist method.

Preferably, the doping agent solution is added to the dispersion of SiO₂ particles in the form of droplets, for example in time-controlled manner according to predetermined time intervals. The extent of mechanical agitation of the dispersion and time interval of droplet addition are preferably matched appropriately such that each droplet is added to a largely homogeneous dispersion and such that a homogeneous distribution of the doping agent or doping agents is thus attained.

Alternatively, and also preferably, the doping agent solution and the SiO₂ particles present in a liquid can be added by means of spray mist method(s). In this context, the doping agent solution is nebulised by means of a spray mist device in one embodiment. Said spray mist field spreads over a relatively large surface of the dispersion of SiO₂ particles that is being kept in motion and thus provides for homogeneous distribution of the doping agent in the dispersion. In an alternative variant of the spray mist method, the SiO₂ suspension can be nebulised and then act on the doping agent solution in the form of a spray mist. In another alternative embodiment, both the doping agent solution and the SiO₂ suspension can be nebulised. According to another alternative embodiment, the doping agent solution and the dispersion of SiO₂ particles are sprayed jointly in a multi-substance nozzle, for example a spray drier. Moreover, more than one spray nozzle can be used in order to ensure an efficient work flow.

In one embodiment of the method according to the invention, the dispersion is a suspension that preferably has a pH between 5 and 12, in particular between 9 and 10. This range ensures high stability of the suspension, since inter-particulate repelling forces diminish the tendency to sediment. On the other hand, this is not lower than the solubility products of the basically poorly soluble doping agents and avoids the use of auxiliary agents, which may lead to undesired impurities. It is preferable to adjust the pH of the suspension through the addition of alkali-free acids or bases, particularly preferably through the addition of ammonia, ammonium salts or amines.

In one embodiment of the method according to the invention, the precipitate is produced in step b) through a pH-controlled precipitation reaction. Preferably, the precipitation of at least a part of the doping agent or doping agents is induced through a precipitation reaction of the doping agents and/or precursor substances thereof, in particular through a precipitation reaction induced through a change of pH. In this context, the pH of the dispersion is preferably adjusted appropriately such that the precipitation reaction commences right away upon the addition of the doping agent. Alternatively, and also preferably, the pH of the dispersion is changed appropriately such that the doping agent, which is initially dissolved in the dispersion, precipitates.

The precipitation usually leads to the formation of fine particles of the doping agent in the dispersion, which not only promotes the homogeneity of the doping agent distribution, but also contributes to the stabilisation of the dispersion. It is essential in this context that the doping agent particles precipitate homogeneously and in defined manner in the still liquid suspension and are adsorbed right away on the SiO₂ particles that are present, which immobilises them.

In one embodiment of the method according to the invention, the pH-controlled precipitation reaction is elicited as a precipitation upon mixing. In said precipitation upon mixing, the pH of the dispersion is preferably adjusted appropriately such that the precipitation reaction of all doping agents commences right away as soon as multiple doping agents are added simultaneously. Preferably, more easily soluble and more poorly soluble doping agents precipitate jointly in this context resulting in a particularly homogeneous distribution of the doping agents and a defined and homogeneous precipitate even if the solubility products of the doping agents differ.

The rate of precipitation of the doping agent can be controlled through the change of the pH of the dispersion of SiO₂ particles. Preferably, the change of pH takes place through a rapid addition of the substance changing the pH. Alternatively, it is preferred to change the pH through a slow addition of the substance changing the pH such that the doping agent precipitates gradually. According to another preferred embodiment, the substance changing the pH is sprayed onto the dispersion of SiO₂ particles and doping agent and/or precursor substance thereof.

The pH of the dispersion may change when the doping agents are added. In order to compensate for this effect, in particular to counter-act a strong drop in pH, the pH of the dispersion is preferably maintained or adjusted, preferably by adding an auxiliary substance, when the dissolved doping agent or precursor substance is added. It is particularly preferable for the dispersion to contain an excess of ammonia that contributes to buffering the pH.

In an alternatively and also preferred variant of the method according to the invention, the pH-controlled precipitation reaction is induced through adjusting the pH of the dispersion to a first lower value, whereby the doping agent is present in the dispersion in dissolved form. Subsequently, the pH value of the dispersion is increased upon which doping agent particles precipitate. This is advantageous in that the dissolved doping agent distributes homogeneously throughout the entire dispersion and including, in particular, any porous SiO₂ particles or aggregates of SiO₂ particles.

Using more than one doping agent for the manufacture of co-doped quartz glass, a procedure is preferred, in which the pH of the dispersion is first adjusted appropriately such that the doping agents are present in the dispersion in dissolved form. Increasing the pH then preferably leads to precipitation of the doping agent particles. Depending on the specific solubility products of the doping agents, the doping agents may precipitate at different times in this context.

In one embodiment of the method according to the invention, inhomogeneous distribution of the doping agents is prevented by increasing the pH through an increase of the temperature of the dispersion in that a compound acting as acid in the dispersion at a lower temperature is made to decompose through increasing the temperature while releasing a substance acting as a base in the dispersion.

In this context, the thermal decomposition of the compound acting as acid preferably takes place concurrently and homogeneously in the volume of the dispersion. This prevents local over-saturation and ensuing concentration differences in the doping agent distribution.

In one embodiment of the method according to the invention, the compound acting as acid at lower temperatures and acting as base in the dispersion at elevated temperature is hexamethylenetetramine (urotropin).

In order to provide for a homogeneous precipitation reaction, the solids content of the dispersion during precipitation of the doping agent(s) is/are preferably is less than 80% by weight, particularly preferably less than 60% by weight, specifically less than 40% by weight, each relative to the total weight of the dispersion.

According to one embodiment of the invention, reducing the amount of the liquid phase of the dispersion in step c) takes place while forming a doped intermediate product. In the scope of one embodiment of the present invention, a liquid phase shall be understood to be a phase that is liquid at 20° C. and preferably is aqueous.

Preferably, the reduction of the liquid phase of the dispersion in the method according to one embodiment of the invention is continued until a solid intermediate product is formed. Preferably, the reduction of the liquid phase of the dispersion takes place in the scope of a granulation.

The granulation of the dispersion preferably proceeds according to known standard methods, such as roll granulation, spray granulation, centrifugal spraying, fluidised bed granulation, rotary evaporator granulation or freeze granulation. Other granulation methods using a granulating mill, by means of compacting, roller compacting, briquetting or extrusion are not excluded either. Said methods are described in the prior art and are known to a person skilled in the art. The granulation process results in an intermediate product in the form of SiO₂ powder, SiO₂ granulate or an SiO₂ green compact that contains the doping agent or doping agents or a precursor substance of a doping agent in finely distributed form and homogeneously distributed.

In one variant of the method according to the invention, the reduction of the liquid phase of the dispersion is preceded by a procedural step, in which solid contained in the dispersion is separated from the liquid by means of a mechanical separation method. In the simplest case and preferably, the mechanical separation takes place through centrifugation. By this means, most of the NH₄Cl, which is also present in the dispersion, can be removed which prevents problems due to the interfering presence of said salt.

In one embodiment of the method according to the invention, a solidification step during which a form body is formed takes place between steps c) and d), in particular through additional compacting of the doped intermediate product into a compact. Preferably, the density of the compact is 20 to 65% of the density of the quartz glass. Preferably, the density of the compact is selected appropriately such that gaseous foreign atoms can penetrate optimally while the shape of the compact is maintained.

Preferably, the solidification step takes place through compacting and/or thermal shaping methods, such as slip casting. Using a low-contamination compression method allows the purity of the form body to largely be maintained. By this means, a homogeneous distribution of foreign atoms, introduced through gas phase doping, in the form body can be attained. The compaction preferably takes place in uniaxial or isostatic manner. Isostatic compacting allows a homogeneous pore distribution in the form body to be implemented. Therefore, an embodiment of the method according to one embodiment of the invention, in which the solidification step takes place through isostatic compaction between steps c) and d) is preferred.

According to one embodiment of the invention, the doped intermediate product is exposed to a fluorine-containing atmosphere. Preferably, the doped intermediate product is rinsed in this context by a gas or a gas mixture containing one or more gaseous fluorine source(s) in order to generate a fluorinated intermediate product. In this context, the gas or gas mixture can comprise additional carrier gases, such as, for example, He, Ar, O₂, and N₂, aside from the gaseous fluorine source(s).

In the scope of one embodiment of the present invention, a fluorine source shall be understood to be a fluorine-containing compound that releases the gaseous fluorination agent when exposed to the process conditions. In this context, the fluorine-containing compound can already be gaseous under standard conditions or it is evaporated during the fluorination process.

In one embodiment of the method according to the invention, the gaseous fluorine source is selected from the group consisting of organic fluorine-containing gases, inorganic fluorine-containing gases and fluorine-containing compounds that are liquid at 25° C., but can be evaporated at process conditions, specifically selected from the group consisting of silicon-fluorine compounds, fluorocarbons, hydrogen fluoride, nitrogen fluorides, sulphur fluorides, metal fluorides, fluoro-hydrocarbons, and chlorofluorohydrocarbons.

Preferably, the gaseous fluorine source is selected from the group consisting of SiF₄, CF₄, SF₄, SF₆, NF₃, HF, C₂F₆, and hexafluorodisiloxane (Si₂OF₆).

It is particularly preferred to use a mixture of several different fluorine-containing and non-fluorine-containing gases as fluorine source. In this context, the composition is selected appropriately such that the desired effects to be attained through fluorination are increased and optimised.

Preferably, the gas or gas mixture used to treat the doped intermediate product contains one or more gaseous fluorine sources(s) in an amount of 0.1 to 100% by volume, preferably 5 to 50% by volume, in particular 10 to 20% by volume, each relative to the total volume of the gas or gas mixture.

One embodiment of the method according to the invention is characterised in that the partial pressure of the gaseous fluorine source is between 10⁻³ and 10,000 mbar, preferably between 10 and 5,000 mbar, in particular between 20 and 1,100 mbar, for example 50 to 1,000 mbar. According to a particularly preferred embodiment, the partial pressure of the gaseous fluorine source is equal to the atmospheric pressure.

In a further preferred embodiment, the treatment of the doped intermediate product with a gas comprising a gaseous fluorine source takes place at temperatures between 300° C. and 1,500° C., preferably between 600° C. and 1,200° C., in particular between 800° C. and 1,000° C.

Preferably, the treatment of the doped intermediate product with the gaseous fluorine source(s) in step d) takes place for a duration of 1 to 10,000 minutes, more preferably 50 to 5,000 minutes, particularly preferably 500 to 3,000 minutes. It has been evident in this context that a duration of treatment of 1,000 minutes to 3,000 minutes, for example 48 hours, is particularly well-suited to attain a homogeneous distribution of fluorine ions, which usually are the dopant. The duration of treatment is preferably selected appropriately such that the desired fluorine content in the doped intermediate product is attained. Preferably, the duration is selected appropriately such that damage to the doped intermediate product by mass losses or etching processes is prevented.

In one embodiment of the method according to the invention, the treatment of the doped intermediate product is a rinsing with a gas containing a gaseous fluorine source, whereby the flow rate of the gas preferably is between 0 sccm and 5,000 sccm, preferably in the range above 0 sccm and below 1,000 sccm, particularly preferably between 10 sccm and 500 sccm.

An embodiment of the method according to one embodiment of the invention, in which the treatment of the doped intermediate product with the gaseous fluorine source takes place in a stationary gas atmosphere (flow rate=0 sccm) is particularly preferred. This allows a homogeneous distribution of the desired amount of fluorine in the doped intermediate product to be attained, since the fluorination is not subject to the influence of gas transport processes in this case.

Different fluorine contents and different fluorine distributions and profiles in the quartz glass can be implemented as a function of the process temperature and pressure, has composition, type of fluorine source, flow rate, and duration of the fluorination process. Preferably, the fluorine distribution and fluorine content in the doped quartz glass are selected appropriately such that the quartz glass has the desired properties.

One embodiment of the method according to the invention is characterised in that the treatment in step d) takes place in a reaction chamber. Preferably, the treatment takes place by means of a specific change of gas and/or change of pressure or through evacuation and subsequent application of the gaseous fluorine source to the reaction chamber, in which the doped intermediate product is situated. Fluorine residues in the reaction chamber can lead to undesired secondary reactions and significant occupational safety risks in the further course. By changing the gas in the reaction chamber in specific manner, interfering fluorine residues are prevented which has a beneficial effect on the homogeneous distribution of fluorine in the doped intermediate product.

In one embodiment of the method according to the invention, an additional treatment step takes place in a chlorine-containing atmosphere, whereby said treatment step takes place between steps c) and d) and/or between steps d) and e), preferably between steps d) and e).

The chlorine-containing atmosphere preferably comprises Cl₂ gas, HCl gas, sulphur chloride or any other chlorine-containing compound. Mixtures of different chlorine- and no chlorine-containing gases can be used just as well. It is customary and preferred to most often use Cl₂ or HCl for the treatment.

Preferably, the treatment of the doped intermediate product in the chlorine-containing atmosphere takes place at temperatures between 700° C. and 1,200° C., more preferably between 800° C. and 1,000° C. Preferably, the duration of treatment in this context is 5 minutes to 20 hours, more preferably 1 hour to 10 hours.

In this context, the treatment comprises further drying and purification steps. It has been evident that the porous SiO₂ granulate body can be dried particularly effectively and rapidly, if the SiO₂ granulate is dried and purified in a chlorine-containing atmosphere. High fluorine concentrations can be attained by this means. Moreover, treatment in a chlorine-containing atmosphere causes the OH content to be reduced further. The low OH content has an advantageous effect both on the formation of bubbles during sintering and on the optical attenuation of the quartz glass at the wavelengths of light affected by OH absorption. Moreover, drying at high temperatures allows the last residues of NH₄Cl to be removed, whose presence would otherwise also lead to the formation of bubbles during sintering. Preferably, the drying temperature is above the sublimation temperature of NH₄Cl, which is removed through sublimation by this means. The drying preferably takes place at temperatures between 150° C. and 400° C., more preferably between 180° C. and 300° C. Preferably, the temperature range is selected appropriately such that remaining residual humidity and NH₄Cl are removed optimally.

In a preferred embodiment, the doped intermediate product can be treated additionally in a chlorine-containing atmosphere between the reduction in step c) and the fluorination step d) in order to dry and purify the doped intermediate product.

One embodiment of the method according to the invention is characterised in that the form body obtained through solidification of the doped intermediate product is treated appropriately with a gas or gas mixture containing one or more gaseous fluorine source(s) such that a fluorinated intermediate product comprising a fluorine concentration gradient is obtained, in which the fluorine concentration of the fluorinated intermediate product decreases from outside towards inside. Preferably, the duration of treatment is selected appropriately such that no equilibrium throughout the entire volume of the form body is established. By this means, the form body comprises a higher fluorine concentration on the edges than on the inside of the form body due to the diffusion profile. An embodiment, in which the form body has a rod-like shape, is particularly preferred.

The fluorine concentration gradient can be generated, for example, through evacuating the form body and/or the reaction chamber, in which the form body is situated, while reducing the pressure. Subsequently, the reaction chamber can be flooded with the gaseous fluorine source. By this means, a form body is obtained that has a higher fluorine concentration in the peripheral regions than in the centre. It is thus feasible to generate gradient index fibres through specific incorporation of fluorine, whereby the fibres comprise special light guiding properties in multi-mode operation.

The method according to one embodiment of the invention comprises a step, in which the fluorinated intermediate product is sintered while forming the doped quartz glass. The sintering in this context preferably takes place according to standard methods known to a person skilled in the art, such as flame melting, gas pressure sintering, vacuum sintering, sintering in a reactive gas atmosphere or sintering in a cladding tube. Said methods are advantageous in that the formation of bubbles, discolouration and crystallisation in the quartz glass are prevented.

In one embodiment of the method according to the invention, the fluorinated intermediate product is pre-sintered in an inert gas atmosphere. Pre-compacted sinter bodies can be attained by this means. Preferably, the pre-sintering takes place in an inert gas atmosphere, preferably in a He atmosphere. The temperatures in this context are preferably in a range between 1,100° C. and 1,700° C., particularly preferably between 1,500° C. and 1,700° C.

Sintering of the fluorinated intermediate product preferably takes place at temperatures between 1,000° C. and 2000° C., more preferably between 1,500° C. and 1,800° C. The pressure in this context preferably is 0.5 MPa to 3.0 MPa, more preferably 1.0 MPa to 2.0 MPa.

In one embodiment of the method according to the invention, the method has to proceed through steps a) through e) in said order.

In one embodiment of the method according to the invention, the sintered fluorinated intermediate product comprises an essentially homogeneous dopant distribution. Preferably, the floating average of the dopant distribution varies by maximally 10%, preferably by maximally 8%, particularly preferably by maximally 5% both in axial and in radial direction. In the scope of one embodiment of the present invention, dopants are substances that are present in the form of positively charged ions, such as, for example the cations of rare earth elements. In order to avoid ambiguous wording and confusion, it shall be noted expressly that fluoride is not included in this category in the scope of one embodiment of the present invention, but rather is mentioned explicitly in all mentions.

An embodiment of the method according to one embodiment of the invention, in which the dopant comprises ytterbium cations, is preferred. These preferably are laser-active ytterbium cations in the form of Yb³⁺.

Fluorine doping can attain a reduction of the melting temperature. This allows defects in the quartz glass caused by thermal effects to be prevented, since the glasses sinter already at lower temperatures. Moreover, the undesired fraction of Yb²⁺, which is generated during the sintering of Yb₂O₃-doped quartz glass at high temperatures and reducing conditions, can be reduced by this means.

Doped quartz glass plays an important role in the manufacture of optically active components. Specific doping of quartz glass allows the properties thereof to be manipulated in specific manner. On the other hand, undesirable effects arising from the doping can be compensated for by incorporating further foreign atoms, such as fluorine.

For this reason, doped quartz glass that can be obtained according to the method according to one embodiment of the invention is another subject matter of the invention.

In one embodiment, the doped quartz glass that can be obtained according to the method according to one embodiment of the invention comprises a fluorine concentration gradient, in which the fluorine concentration in the doped quartz glass decreases from outside towards inside. Preferably, the doped quartz glass also comprises a higher fluorine concentration in the peripheral regions as compared to the centre. It is particularly preferred to use said doped quartz glass comprising a fluorine concentration gradient in gradient index fibres that have a lower refractive index at the periphery as compared to the centre.

In a further embodiment, the distribution of the dopant in the doped quartz glass is essentially homogeneous. In this context, the fluorine-doped quartz glass obtained according to one embodiment of the invention comprises a constant dopant profile without any zones in the centre or in the peripheral region, in which the dopant exits by diffusion, such as is the case with fluorine-doped quartz glass manufactured according to standard methods known from the prior art. Preferably, the quartz glass that can be obtained according to one embodiment of the invention has a dopant profile with a floating average that varies by maximally 10%, more preferably by maximally 8%, particularly preferably by maximally 5%, both in axial and radial direction.

Fluorine doping of quartz glass allows the sintering temperatures to be reduced, which in turn has an advantageous effect on the content of undesired non-laser-active Yb²⁺ ions in the quartz glass. These are generated from the desired laser-active Yb³⁺ cations due to the high sintering temperatures and reducing conditions during the sintering process. The Yb³⁺ cation content plays a major role in the determination of the optical properties of the quartz glass.

Therefore, an embodiment, in which the doped quartz glass is characterised in that the dopant comprises ytterbium cations, is preferred. An embodiment, in which the dopant comprises Yb³⁺ cations, is particularly preferred.

It has surprisingly been found that quartz glass doped with rare earth elements and, in addition, fluorinated according to the method according to one embodiment of the invention shows a marked improvement in ageing resistance. Accordingly, additional incorporation of fluorine significantly reduced the so-called photo-darkening, in which the material darkens subsequently during laser operation, i.e. in which the basic attenuation of the material increases and the laser efficiency thus decreases.

Therefore, the quartz glass according to one embodiment of the invention is used to reduce photo-darkening effects in laser-active materials in a preferred embodiment. In this context, an embodiment of the quartz glass according to one embodiment of the invention that also comprises aluminium and ytterbium cations aside from fluoride, is preferred. A mixture, in which the amount of aluminium cations is at least twice, thrice, and four times the amount of ytterbium cations, each relative to the total quantity of metal dopants, is preferred, more preferred or particularly preferred, respectively.

In the scope of one embodiment of the present invention, aluminium and ytterbium are always to be understood to be dopants, i.e. in the form of the respective cation. In the scope of one embodiment of the invention, this term does not include the metal in its neutral form.

An embodiment, in which the quartz glass is additionally doped with phosphorus aside from aluminium and fluorine, is also preferred.

It has also surprisingly been found that the presence of aluminium ions allows the fluorine content incorporated into the quartz glass to be increased. Quartz glass manufactured according to the method known in the prior art can be doped with fluorine only to a certain level, which often is insufficient, for example, to compensate the increase in the refractive index of the quartz glass through other dopants, namely rare earth elements. The higher fluorine content in quartz glass that can be attained through the method according to one embodiment of the invention and, in particular, through co-doping with aluminium, allows doped quartz glass to be manufactured that has a refractive index analogous to the refractive index of non-doped quartz glass. Therefore, an embodiment of doped quartz glass, in which the dopant comprises aluminium cations, is preferred. An embodiment, in which the dopant comprises Al³⁺ cations, is particularly preferred. An embodiment, in which the dopant comprises a mixture of aluminium and ytterbium is also preferred, whereby an embodiment, in which the aluminium is present at an excess over the amount of ytterbium, is particularly preferred. Moreover, an embodiment, in which the dopant also comprises phosphorus cations, replacing or supplementing the aluminium cations, is also preferred.

Most dopants for quartz glass doping lead to an increase in the refractive index of the quartz glass. In contrast, the incorporation of fluorine decreases the refractive index. This it is feasible to adjust the refractive index of quartz glass to a definite level through appropriate selection of the co-dopants, such as aluminium and ytterbium.

In another preferred embodiment, the fluoride concentration in the doped quartz glass is more than 0.6 mol %, preferably more than 0.65 mol %, in particular between 0.7 mol % and 2.5 mol %, and particularly preferably between 0.8 mol % and 1.8 mol %, each specified as mol % of SiF₄.

The doped quartz glass that can be obtained according to the method according to one embodiment of the invention preferably is a laser-active quartz glass.

In one embodiment, the quartz glass that can be obtained according to the method according to the invention is used as anti-guiding laser fibre. In the scope of the present invention, anti-guiding laser fibres shall be understood to mean structures, in which the laser-active core has a lower refractive index than the cladding and would not guide any light under normal circumstances. Said laser, for example a fibre laser, can be made to have the core be light-guiding by hard pumping.

The method according to one embodiment of the invention can be used to adjust both the fluorine content and the fluorine profile of the quartz glass in specific manner. Accordingly, pre-forms and fibres of a light-guiding structure can be manufactured without any further pre-form manufacturing steps, such as flashing or depositing layers. Accordingly, in a further embodiment, the quartz glass that can be obtained according to the method according to the invention is used for the manufacture of pre-forms and fibres for the generation of a light-guiding structure. By this means, boundary-free structures having a certain refractive index profile can be produced. Therefore, the quartz glass that can be obtained according to one embodiment of the invention is used, in particular, for gradient index fibres in a preferred embodiment.

The incorporation of foreign atoms into the quartz glass allows the properties thereof to be controlled and affected in specific manner. Dispersion-optimised and/or dispersion-adjusted glasses can thus be manufactured. Therefore, the use of the quartz glass that can be obtained according to the method according to one embodiment of the invention in optical applications, in particular selected from the group consisting of filter glassware, converter glassware, lenses, and sensors, is preferred.

The method according to one embodiment of the invention allows the properties of the quartz glass, such as tension and spliceability, as well as the thermo-optical and thermodynamic expansion coefficients to be optimised. Therefore, in a preferred embodiment, the quartz glass that can be obtained according to the method according to one embodiment of the invention is used for fibre end-caps. Due to the optimised thermo-optical and thermo-mechanical properties of the quartz glass according to one embodiment of the invention, the focus shift, which normally occurs when the glass is heated, is minimised.

The method according to one embodiment of the invention allows the viscosity of the quartz glass to be adjusted. This is of interest especially for laser-active and laser-passive specialised fibres, in which the viscosity of core and cladding should be matched to each other. Therefore, the use of the quartz glass that can be obtained according to the method according to one embodiment of the invention in core-cladding glass fibres is preferred.

In the following, embodiments of the invention are illustrated in more detail on the basis of exemplary embodiments.

### Example 1

### Part A

For manufacture of a Yb₂O₃- and Al₂O₃-doped quartz glass, a suspension of SiO₂ nano-particles in ultra-pure water was produced. The pH was adjusted to 9.5 by adding a concentrated ammonia solution. The solids content of the alkaline suspension was 50% by weight.

Doping agents were added to the alkaline suspension in dissolved form and through time-controlled addition of droplets of an aqueous doping agent solution of AlCl₃ and YbCl₃ at a molar ratio of 4:1 while stirring continuously. The time interval between the consecutive additions of droplets of the doping agent solution was adjusted to 1 second, which ensures that each droplet reached an already homogenised suspension.

Due to the high pH of the suspension, hydroxides of the two doping agents precipitate due to the mixing as Al(OH)₃ and Yb(OH)₃ right away. The solid particles thus formed adsorb to the existing surfaces of the SiO₂ particles and are thus immobilised such that agglomeration of the solid particles or sedimentation is prevented. By this means, a doping agent concentration of the suspension is adjusted to 2 mol % Al and 0.5 mol % Yb, each relative to the Si content of the suspension.

The volume fraction of the doping agent solution is 20% of the initial volume of the suspension. During doping, the previously adjusted pH of the suspension is kept constant through an excess ammonia in the suspension and, if necessary, further addition of ammonia and ultra-pure water in order to prevent unequal conditions from occurring during the chemical precipitation of the dopants and gelling of the suspension. The hydroxide compounds of the dopants are thus homogeneously distributed in the suspension. The suspension was stirred continuously.

Then the suspension to which the doping agent had been added was granulated in a rotary evaporator. In this context, the moisture was removed very rapidly from the suspension through the generated heat. Accordingly, the porous SiO₂ granulate thus produced contained finely and homogeneously distributed Al(OH)₃ and Yb(OH)₃ particles in an amount, which, in oxidic form, effects doping of the quartz glass with 1 mol % Al₂O₃ and 0.25 mol % Yb₂O₃.

The SiO₂ granulate was pre-treated at 200° C. for a duration of 24 hours in an oxygen atmosphere. Residual moisture and NH₄Cl were removed in the process. Subsequently, the granulate was processed in isostatic manner into compacts at a pressure of 100 MPa. The compacts thus produced were dried by heat in a drying cabinet.

### Part B

The compacts obtained in Part A were subjected to an atmosphere containing 20% by volume SiF₄ and 80% by volume N₂ for a duration of 9 hours at 900° C. at a total gas flow rate of 100 sccm.

Then the fluorinated compacts were subjected to a chlorine-containing atmosphere for 5 hours at a temperature of 900° C. Then the compacts were pre-sintered at 1,600° C. in a He atmosphere in the same furnace. Pre-compacted sintering bodies were thus produced.

The pre-compacted sintering bodies were first heated to 1,740° C. in a vacuum and then vitrified at the same temperature at a pressure of 1.5 MPa.

### Example 2

One compact was adjusted appropriately according to the method described in Example 1, Part A such that it was doped with 3 mol % Al₂O₃ and 0.15 mol % Yb₂O₃. The compact had a density of 50% of the theoretical density of quartz glass and an external diameter of 18 mm and a length of 65 mm and was then introduced into a quartz glass cladding tube and the cladding tube was evacuated. Then SiF₄ and He were applied to the cladding tube at a partial pressure of 500 mbar, relative to the fluorine carrier SiF₄. The cladding tube was heated from outside using an oxyhydrogen torch until the external tube was at a temperature of 1,200° C. Heating along the tube was implemented by moving the torch along the tube axis at a rate of 1 cm per minute. The prevalent temperature gradient along the radius of the compact leads to different reactivity of SiF₄ with the compact, which is reflected in a different fluorine concentration, whereby the distribution of the dopants, Al and Yb, remains constant.

### Example 3

A compact doped with 4.5 mol % Al₂O₃ was produced according to the method described in Example 1, Part A. The compact had a diameter of 18 mm and a length of 50 mm. The compact was placed in a reactor that was evacuated and then charged with SiF₄. The compact was treated for 3 hours at 900° C. A constant gas flow of 50 sccm SiF₄ was maintained in this context. Then, the body was sintered and vitrified simultaneously in the cladding tube using a torch.

### Example 4

### Adjusting a Refractive Index Profile

A compact with a diameter of 4.0 cm, length of 15 cm, and a green compact density of 45% as compared to the theoretical density of quartz glass was fluorinated for 45 minutes at a temperature of 900° C. using a gas mixture consisting of 20% by volume C₂F₆ and 80% by volume of nitrogen, whereby the total flow rate was 50 cm³ per minute. The glass was vitrified at a temperature of 1,600° C. in a vacuum and drawn into a rod of 20 mm in length on a glass maker's turning lathe at 1,900° C.

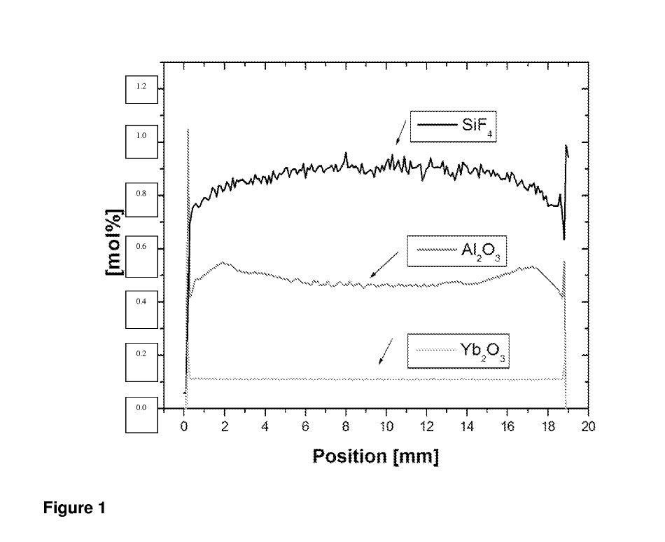

FIG. 1 shows an ESMA analysis by means of a WDX scan across an Yb/Al-doped quartz glass sample that was manufactured according to Example 1 of the method according to one embodiment of the invention. The sample shows a very homogeneous Yb₂O₃ profile with no zone of material diffusing out either in the peripheral region or the centre. Even after an additional intensive heat processing step, there was essentially no notable diffusion of the dopants out of the material. As shown in FIG. 1, there is no depletion of Yb₂O₃ in the peripheral regions, which is commonly observed with rare earth element-doped MCVD materials co-doped with fluorine.

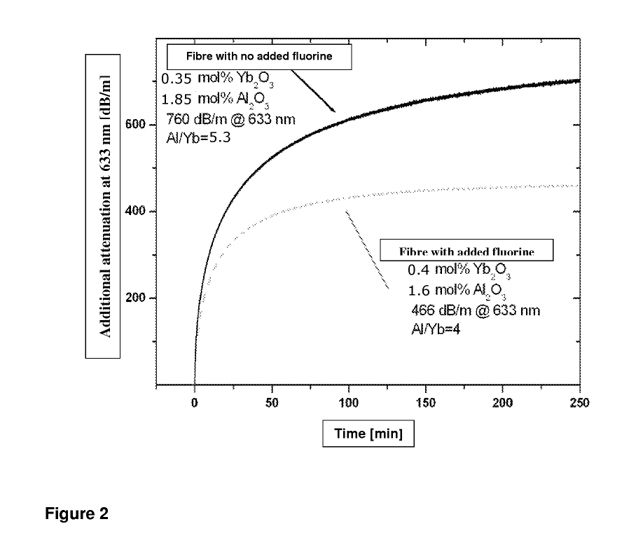

FIG. 2 shows a comparison of two fibres doped with similar Yb and Al concentrations, whereby the fluoride-containing fibre was manufactured according to the method according to one embodiment of the invention. Considering the heretofore known dependence of the photo-darkening behaviour of doped quartz glass on various parameters, one would have expected the fluorine-doped fibre to show a more pronounced photo-darkening behaviour than the fluorine-free fibre, since the fluorine-doped fibre has not only a higher Yb content, but also a lower Al/Yb ratio, which all are indicative of increased photo-darkening. As is evident from the figure, photo-darkening is significantly reduced by co-doping with fluorine. Depending on the fluorine content and the ratio of Al and Yb ions, photo-darkening can be reduced by up to a third as compared to glasses containing no fluorine.

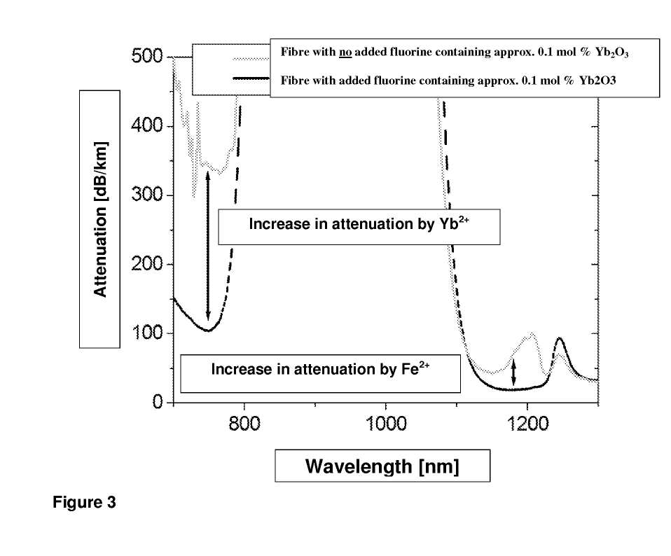

FIG. 3 shows a fibre attenuation spectrum of a glass manufactured according to the method according to one embodiment of the invention. The spectrum of a glass of the same Yb₂O₃ content, but no fluorine co-doping, serves for purposes of comparison. Looking at the wavelength range of the spectrum above 800 nm, it is evident that fluorine doping of quartz glass can clearly suppress a yellowish discolouration of the glass. The yellowish discolouration is due to an increasing number of Yb²⁺ ions, which leads to an increase in the attenuation in the blue range of the spectrum. Due to doping with fluorine, basically no Yb²⁺ is incorporated into the glass matrix despite the reducing sintering conditions. Accordingly, the transmission of the glasses in the blue range of the spectrum improves, meaning that the attenuation in this spectral range decreases.

Moreover, fluorine doping was surprisingly found to mask the Fe²⁺ contamination in the glass. Fe²⁺ is characterised by a broad absorption band in the range between approx. 1,100 nm and 1,200 nm. This band is markedly reduced in the fluorine-doped glasses since the Fe contamination is masked by the fluorine, as is evident for the wavelength range from approx. 1,100 nm to approx. 1,200 nm in FIG. 3.

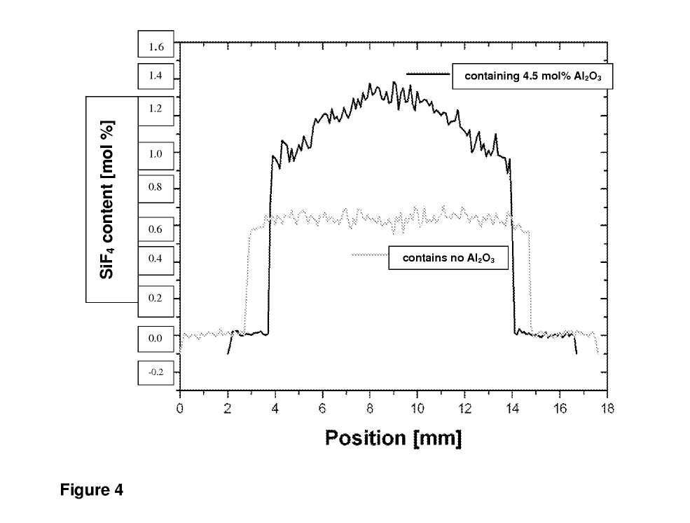

In addition, it was found that markedly more fluorine can be incorporated into Al-doped materials than in non-doped quartz glass by means of the method according to one embodiment of the invention. In contrast to previous experience with aluminium-doped and rare earth element-doped quartz glass, fluorination according to the method according to one embodiment of the invention has been found to allow up to a factor of 2 more fluorine to be incorporated as compared to non-doped material under the same experimental conditions. FIG. 4 shows two samples of which one is doped with fluorine alone, whereas the second was manufactured according to the method according to one embodiment of the invention and contains 4.5 mol % Al₂O₃. As is evident from FIG. 4, markedly more fluorine was incorporated into the Al-co-doped sample, in particular in the central region, as compared to the non-doped sample.

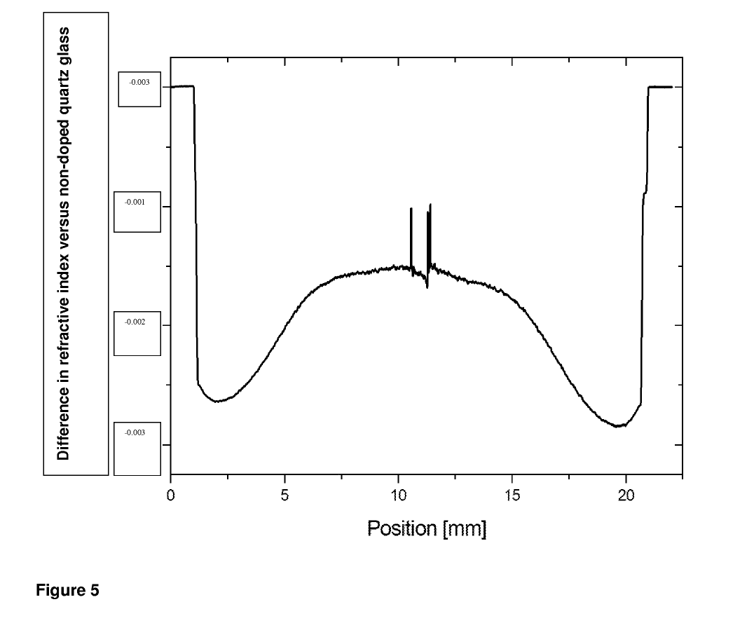

FIG. 5 shows a refractive index profile of a quartz glass manufactured according to Example 4. As is evident from the figure, time-controlled fluorination of the quartz glass allows the refractive index profile of the quartz glass to be modified appropriately such that the peripheral regions of the quartz glass have a lower refractive index than the centre. Fluorination of quartz glass lowers the refractive index thereof, which is in contrast to most other dopants, which, when incorporated, increase the refractive index. The higher the amount of fluoride in quartz glass, the lower the refractive index thereof. The time-controlled incorporation of fluoride into the quartz glass in this case allows a refractive index profile to be adjusted appropriately such that it meets the individual requirements of the situation on hand.

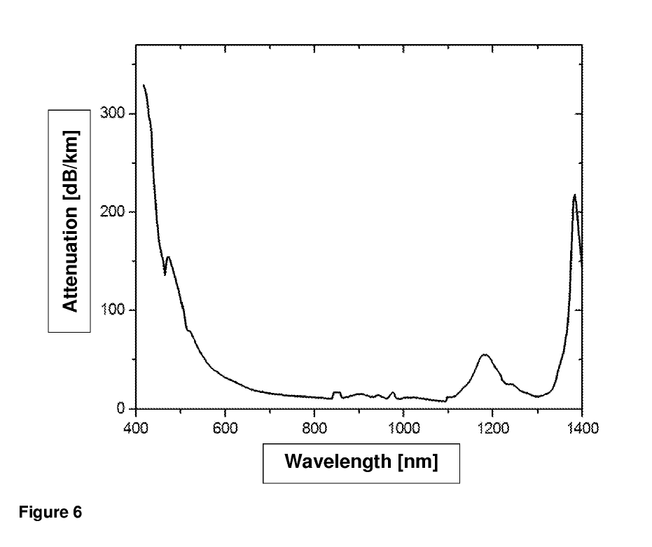

FIG. 6 shows the attenuation spectrum of a quartz glass manufactured according to Example 4 from which a fibre with an external diameter of 125 μm was produced at a drawing temperature of 1,850° C. and a drawing rate of 10 m/min without any further cladding steps. The fibre was coated with acrylate for mechanical protection. The attenuation in the spectral range must be considered to be low; only the range around 1,200 and 1,350 nm shows absorption bands due to OH impurities that can usually be removed easily by introducing a chlorination step. As is evident from the figure, a quartz glass that can be obtained according to one embodiment of the invention can be processed into a fibre having a light-guiding structure through the controlled reaction with fluorine and no boundaries are required in the manufacture of the light-guiding structure.

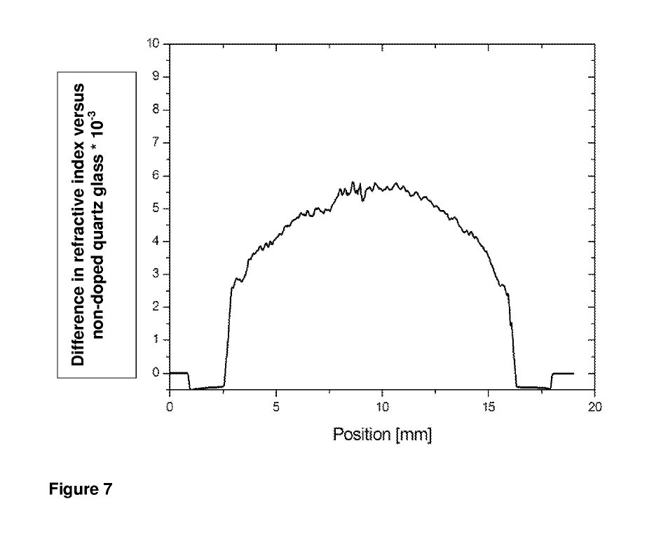

FIG. 7 shows the refractive index profile of a quartz glass manufactured according to Example 2. The gradient index of the profile was implemented through controlled F-doping. Since fluorine lowers the refractive index of quartz glass, the quartz glass has a lower refractive index in places with a higher fluoride concentration, such as the peripheral regions, than in the centre. The parabolic shape of the refractive index profile in the quartz glass was implemented by this means.

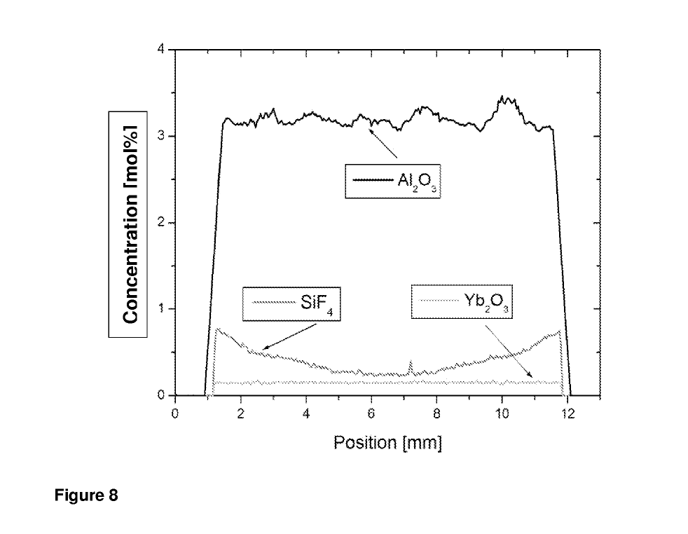

FIG. 8 shows the elemental distribution of a quartz glass manufactured according to Example 2 as determined by electron beam microscopy. As is evident from the figure, the gradient profile of the fluoride concentration has no influence on the concentration distribution of the dopants, aluminium and ytterbium.

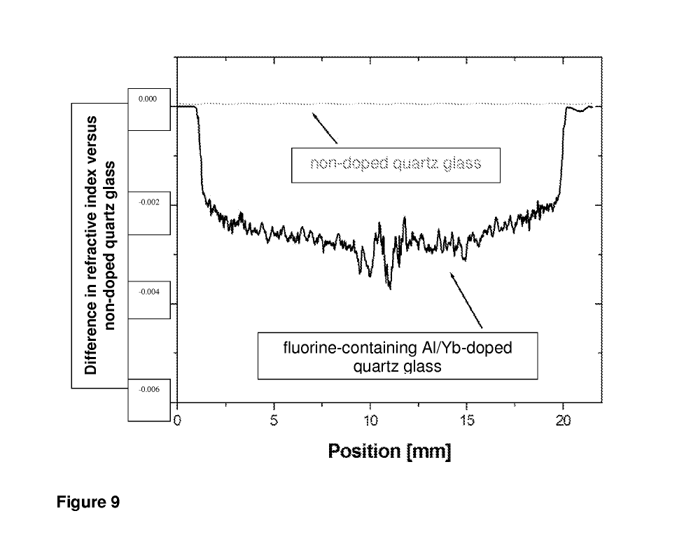

FIG. 9 shows the refractive index structure of a quartz glass manufactured according to Example 1, which is doped with 0.12 mol % Yb₂O₃, 0.5 mol % Al₂O₃, and 0.8 mol % SiF₄, with a strong drop of the refractive index as compared to non-doped quartz glass, suitable for manufacture of an anti-guiding laser fibre. The fluorine content in said glass was adjusted appropriately resulting in a typical refractive index difference of approx. 10⁻³ as compared to non-doped quartz glass, albeit with a negative sign in this case. Combining said glass with non-doped quartz glass allows a so-called anti-guiding structure to be implemented easily, which has the potential to generate laser light under certain excitation conditions.

1-32. (canceled)

33. A method of manufacturing doped quartz glass, comprising:
a) providing a dispersion containing
1) SiO₂ particles and
2) a component selected from the group consisting of a doping agent and a precursor substance of a doping agent and any mixture thereof, in a liquid;
b) generating a precipitate of at least a part of the doping agent and/or precursor substance of a doping agent in the dispersion;
c) reducing the amount of the liquid phase of the dispersion while forming a doped intermediate product;
d) treating the doped intermediate product with a gas or a gas mixture that contains one or more gaseous fluorine source(s) while generating a fluorinated intermediate product; and
e) sintering the fluorinated intermediate product while forming the doped quartz glass.

34. The method of claim 33, wherein the gaseous fluorine source is selected from the group consisting of organic fluorine-containing gases, inorganic fluorine-containing gases and fluorine-containing compounds that are liquid at 25° C., but can be evaporated at process conditions, specifically selected from the group consisting of silicon-fluorine compounds, fluorocarbons, hydrogen fluoride, nitrogen fluorides, sulphur fluorides, metal fluorides, fluoro-hydrocarbons, and chlorofluorohydrocarbons.

35. The method of claim 33, wherein the gaseous fluorine source is selected from the group consisting of SiF₄, CF₄, SF₄, SF₆, NF₃, HF, C₂F₆, and hexafluorodisiloxane (Si₂OF₆).

36. The method of claim 33, wherein the gas or gas mixture used in d) contains the one or more gaseous fluorine sources(s) in an amount of 5 to 50% by volume relative to the total volume of the gas or gas mixture.

37. The method of claim 36, wherein the gas or gas mixture used in d) contains the one or more gaseous fluorine sources(s) in an amount of 10 to 20% by volume relative to the total volume of the gas or gas mixture.

38. The method of the claim 33, wherein the partial pressure of the gaseous fluorine source is between 10 and 5,000 mbar.

39. The method of the claim 38, wherein the partial pressure of the gaseous fluorine source is between 50 to 1,000 mbar.

40. The method of claim 33, wherein the treatment of the doped intermediate product with a gas containing one or more gaseous fluorine source(s) takes place at temperatures between 600° C. and 1,200° C.

41. The method of claim 40, wherein the treatment of the doped intermediate product with a gas containing one or more gaseous fluorine source(s) takes place at temperatures between 800° C. and 1,000° C.

42. The method of claim 33, wherein the doped intermediate product is treated with the gaseous fluorine source(s) in d) for a duration of 50 to 5,000 minutes.

43. The method of claim 33, wherein the doped intermediate product is treated with the gaseous fluorine source(s) in d) for a duration of 500 to 3,000 minutes.

44. The method of claim 33, wherein the treatment in d) is a rinsing, whereby the flow rate of the gas or gas mixture containing the gaseous fluorine source(s) is between 0 sccm and below 1,000 sccm.

45. The method of claim 33, wherein the treatment in d) is a rinsing, whereby the flow rate of the gas or gas mixture containing the gaseous fluorine source(s) is between 10 sccm and 500 sccm.

46. The method of claim 33, wherein the treatment in d) in a reaction chamber takes place by means of a specific change of gas and/or change of pressure or through evacuation and subsequent application of the gaseous fluorine source to the reaction chamber, in which the doped intermediate product is situated.

47. The method of claim 33, wherein the precipitate is generated in b) through a pH-controlled precipitation reaction.

48. The method of claim 33, wherein the dispersion is a suspension which has a pH between 5 and 12.

49. The method of claim 33, wherein the one or more oxides of rare earth elements is/are used as doping agent and/or precursor substance of the doping agent.

50. The method of claim 33, wherein one or more oxides selected from the group consisting of Al₂O₃, Yb₂O₃, Ce₂O₃, Nd₂O₃, Sm₂O₃, Er₂O₃, Tm₂O₃, La₂O₃, Y₂O₃, Eu₂O₃, Ho₂O₃, Pr₂O₃, NbO₂, Ni₂O₃, TaO₂, ZrO₂, GeO₂, B₂O₃, P₂O₃, Sc₂O₃, SnO₂, CrO, Cr₂O₃, CrO₂, NiO, ZnO, MgO, CaO, SrO, BaO, MnO₂, Ga₂O₃, and TiO₂ are used as doping agent.

51. The method of claim 33, wherein providing the dispersion in a) takes place by SiO₂ particles present in a liquid being added to the doping agent(s) and/or the precursor substance(s) thereof in the form of droplets and/or through a spray mist method.

52. The method of claim 33, wherein an additional treatment takes place in a chlorine-containing atmosphere, whereby said treatment takes place between c) and d) and/or between d) and e), preferably between d) and e).

53. The method of claim 33, wherein a solidification step, during which a form body is formed, takes place between c) and d), in particular through an additional step of compacting the doped intermediate product while forming a compact.

54. The method of claim 53, wherein the form body, preferably the compact, is treated appropriately with a gas or gas mixture containing one or more gaseous fluorine source(s) such that a fluorinated intermediate product comprising a fluorine concentration gradient is obtained, in which the fluorine concentration of the fluorinated intermediate product decreases from outside towards inside.

55. The method of claim 33, wherein the floating average of the dopant distribution in the sintered fluorinated intermediate product varies by maximally 10%, in axial and/or radial direction.

56. The method of claim 55, wherein the dopant comprises ytterbium cations.

57. A method comprising producing doped quartz glass according to claim 33 and characterized in that the doped quartz glass comprises at least one of:
a fluorine concentration gradient, in which the fluorine concentration in the doped quartz glass decreases from outside towards inside;
the dopant is distributed essentially homogeneously in the doped quartz glass;
the dopant comprises ytterbium cations;
the dopant comprises aluminium cations;
the fluoride concentration in the doped quartz glass is more than 0.6 mol %;
the fluoride concentration in the doped quartz glass is more than 0.65 mol %;
the fluoride concentration in the doped quartz glass is between 0.7 mol % and 2.5 mol %;
the fluoride concentration in the doped quartz glass is between 0.8 mol % and 1.8 mol %; and
a laser-active quartz glass.

58. A method comprising;
producing doped quartz glass according to claim 33; and
producing, from the doped quartz glass, at least one of:
anti-guiding laser fibres;
pre-forms and fibres for generating a light-guiding structure;
gradient index fibres;
filter glassware;
converter glassware;
reduced photo-darkening in laser-active materials;
lenses;
sensors;
fibre end-caps; and
core-cladding glass fibres.
